(19) United States
(12) Patent Application Publication
(10) Pub. No.: US 2010/0037092 A1
(43) Pub. Date: Feb. 11, 2010

(54) SYSTEM AND METHOD FOR BACKUP, REBOOT, AND RECOVERY

(76) Inventor: Urbano Zamora, Plantation, FL (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/187,572

(22) Filed: Aug. 7, 2008

(51) Int. Cl. G06F 11/07

(52) U.S. Cl. 714/6; 714/E11.021

(57) ABSTRACT

The invention makes it possible to restart and effectively use a computer by connecting a machine readable backup device which is recognized by the computer as a bootable drive. The device includes an emergency operating system executable from the backup medium in the event the computer's internal storage drive (hard disk) or operating system crashes and without using data from the computer's hard disk or other internal storage (which may be affected by the crash), data backup and recovery applications, data generated by the backup and recovery applications, and a productivity suite. The productivity suite includes a word processing application, a spreadsheet application, a slide presentation application, an Internet browsing application, and/or an email handling application. The emergency operating system and productivity application make it possible to regain much of the computer's functionality and to provide access to files backed-up by the invention, even if it is not possible to access data or programs stored on the computer's internal storage drive.

### BACKGROUND OF THE INVENTION

1. Field of the Invention

The present invention relates to the field of using consumer-installable plug-and-play devices for backing up and recovering computer data, and for restarting and effectively operating a computer whose storage drive (e.g., internal or external boot drive) or operating system has failed.

2. Background Description

Computer users are typically advised to back up computer data in order to protect against losing data through accidental or malicious corruption of a data storage system. In enterprise computing, automated regular backups are the norm through network-based data archiving technologies installed and operated by full-time information technology specialists. But for individual computer users, either at the home or in the context of a businessman's notebook computer, the use of backup technology continues to be the exception rather than the rule, at least in part because of the perceived complexity and/or inconvenience of installing and operating an appropriate backup solution, or cost.

In addition, there are no available solutions that, in addition to providing backup software and backup storage, also provide an emergency operating system and a productivity software suite, all in one single unit, recognizable by a computer as a bootable drive and allowing a user to restart, operate and have access to the user's files after the user's computer has failed due to internal storage drive failure or corruption of the operating system.

### SUMMARY OF THE INVENTION

It is the object of the present invention to provide an easy-to-use backup, reboot, and recovery solution suitable for the computing environment of individual users, both in terms of price and in terms of ease of use and functionality.

To this end, software to perform backup, recovery, and restoration of computer data is loaded onto peripheral hardware providing nonvolatile machine-readable storage capacity for backup data. The peripheral hardware is set up to be viewed by the computer as a data storage drive from which the computer can be booted, such as when the default boot drive is not available. The provided software is run by the computer directly from the peripheral hardware. Because the data is stored within the present invention and not in other media (e.g., CDs), the backups are automatic and there is no user involvement.

In addition to software for automated backup and file recovery, the provided software includes an emergency operating system capable of booting the computer. This makes it possible to provide the user with access to the computer and its peripherals in the event of a catastrophic failure affecting the computer's internal storage drive or operating system.

The provided software also includes a productivity suite—including, but not limited to, word processing, spreadsheet, slide presentation, Internet browsing, and email handling applications—to provide basic functionality in the event the computer's internal storage drive, operating system, or the applications themselves, become unusable.

Thus, according to the present invention, if a computer's storage drive (e.g., internal or external hard drive or other device—“internal storage drive” and “hard drive” being used for convenience hereinafter) or operating system cannot recover from a crash, the user can restart and boot the computer using the emergency operating system provided on the hardware peripheral. It is not necessary for the emergency operating system to be the same as the computer's default operating system.

Once the computer is booted using the emergency operating system, a user can use software located on the hardware peripheral of the present invention to operate the computer directly from the emergency operating system and use the productivity suite provided on the hardware peripheral of the present invention. In addition, because the present invention had been used to back-up the user's files before the computer crashed, these files are now available to be reviewed and edited by the productivity suite, or to be sent to another computer via the Internet or another network. As a result, the computer has not only been re-started and a software productivity suite made available, but the user's files are also made available through the back-ups that have been done and stored on the device. It is not necessary for the productivity applications to be the same productivity applications as are installed on the computer, as long as they are capable of using the same data.

Finally, the present invention can be implemented in a low-cost hardware format, including, but not limited to a flash-drive-sized connected to a computer via a universal serial bus (USB) port, a Personal Computer Memory Card International Association (PCMCIA) card, or a unit integrated into the computer system as an internal component. In this way, a backup solution may be provided at a price point low enough for the individual user (as opposed to the enterprise) marketplace.

Thus, for example, a traveling businessman intending to make a presentation using slides located on a notebook computer would be able to update the slides and make the presentation from the notebook using the emergency operating system and productivity suite—even in the event of a catastrophic failure of the computer's internal storage drive or operating system. Similarly, after a family's home computer is invaded by a virus on the night before PTA budget projections are due to be presented, a parent could use the present invention to resuscitate the computer using the emergency operating system and backed up data. These situations have typically fallen through the cracks of traditional data backup strategies. The ease of use, small size, and low price of the present invention are not available from other solutions.

The present invention thus provides a system and a method for restarting and effectively operating a data processing apparatus by (a) connecting a machine-readable backup medium to the data processing system as a bootable drive, the following being stored on said backup medium: (i) an operating system executable from the backup medium as boot drive, (ii) a data backup application, (iii) backup data generated by the data backup application, (iv) a data recovery application, and (v) a productivity suite comprising at least one of a word processing application, a spreadsheet application, a slide presentation application, an Internet browsing application, and an email handling application; (b) booting the data processing apparatus from the operating system stored on the backup medium; (c) processing the backup data on the data processing apparatus using the data recovery application or the productivity suite; and (d) storing data generated by the foregoing step of processing the backup data on a data storage medium connected to the data processing apparatus. The machine-readable backup medium may be a flash drive and may be connected to the data processing apparatus by a USB port, or may be provided on a PCMCIA card or via any other available connection port, such as Serial ATA (SATA). The storage medium connected to the data processing apparatus, on which data generated by processing backup data is stored, may not be the backup medium. The operating system may be a Linux operating system.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram showing a prior art computer system boot process.

FIG. 2 is a block diagram showing the preferred embodiment of the invention in both of its operating modes: a) performing backups when the computer is functioning normally, and b) restarting and operating the computer after its hard disk or operating system has crashed.

FIG. 3 is a screen shot of an exemplary system startup screen.

FIG. 4 is an exemplary screen shot of a system booting from the emergency operating system.

FIG. 5 is an exemplary screen shop of the system desktop after booting from the emergency operating system.

FIG. 6 is an exemplary screen shot of an application launching from the hardware device's productivity suite.

FIG. 7 is an exemplary tool bar showing an indicator when the storage capacity of the nonvolatile memory has reached a threshold value (e.g., 75% full).

FIG. 8 shows the Back in a Flash™ unit plugged into the USB port of a computer where the data and application storage medium is connected to the computer through a USB connector.

### DETAILED DESCRIPTION

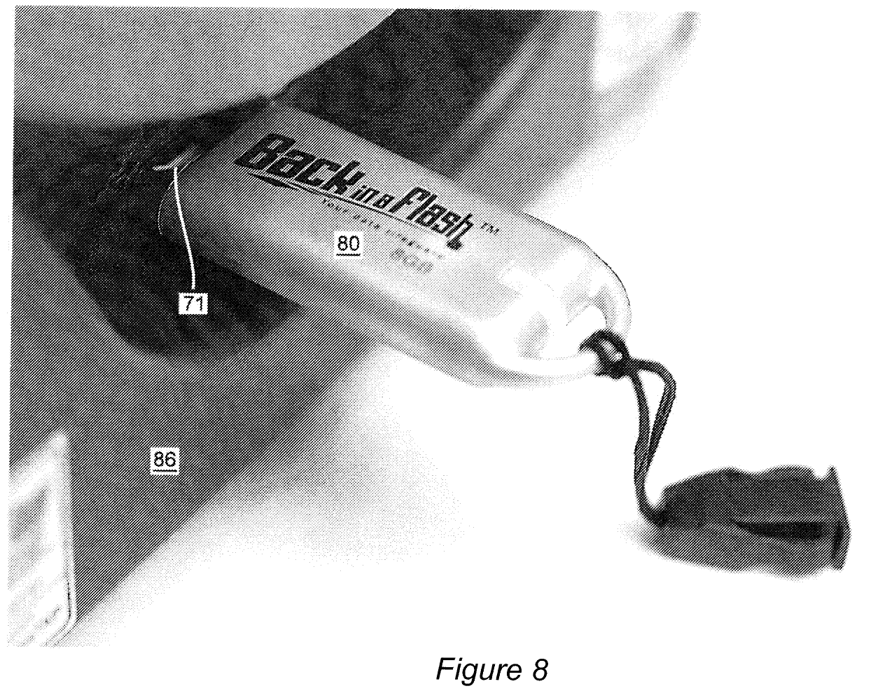

In the preferred embodiment, the hardware peripheral device embodying the present invention is the size and shape of a standard USB flash drive (as shown schematically in FIG. 8). This is a much lower cost format that traditional data backup devices. The device preferably plugs into any USB port of a computer and, with one click, starts an automatic process of backing up the user's files every day. The preferred embodiment also allows users to resuscitate a crashed PC, one that has failed due to a crash of its internal storage drive (hard disk) or corruption of its operating system. The backup device has a built-in operating system, which enables a user to boot up the computer from the backup device. It also has a software suite compatible with Microsoft Office®. This suite can be used to create new documents, spreadsheets and presentations, or to open and edit those that are stored inside the device by the daily back-ups. The software suite can also be used to surf the Web, send and receive email, do instant messaging, listen to music, play movies, and more. All without calling on the computer's operating system, hard disk or software, or on the user's software and files lost or inaccessible inside the computer.

Software that has been preloaded onto the hardware peripheral manages the backup process, compresses and encrypts the backup files, and stores them inside the device's nonvolatile memory. Because the software is preloaded onto the device, the user does not have to install software onto the computer. Recovery of files may be performed by the computer's file manager when the computer is functioning properly or by the device's operating system when the device is in the “resuscitation” mode following failure of the computer's internal storage drive (hard disk) or operating system. The backed-up files are inside the device and the user, treating the device like any other drive, simply opens the files, like any other encrypted, compressed file using a file manager application provided by the operating system. The resuscitation of a crashed computer requires some user intervention.

In the majority of computer failures, even catastrophic failures, two key elements are undamaged: the processor and the random access memory (RAM), where data is stored temporarily while in use. The present invention takes advantage of this by making these two elements available for use through an operating system and productivity applications located on the hardware peripheral device. Copies of a user's working data files are also located on the device as a result of the data back-up process.

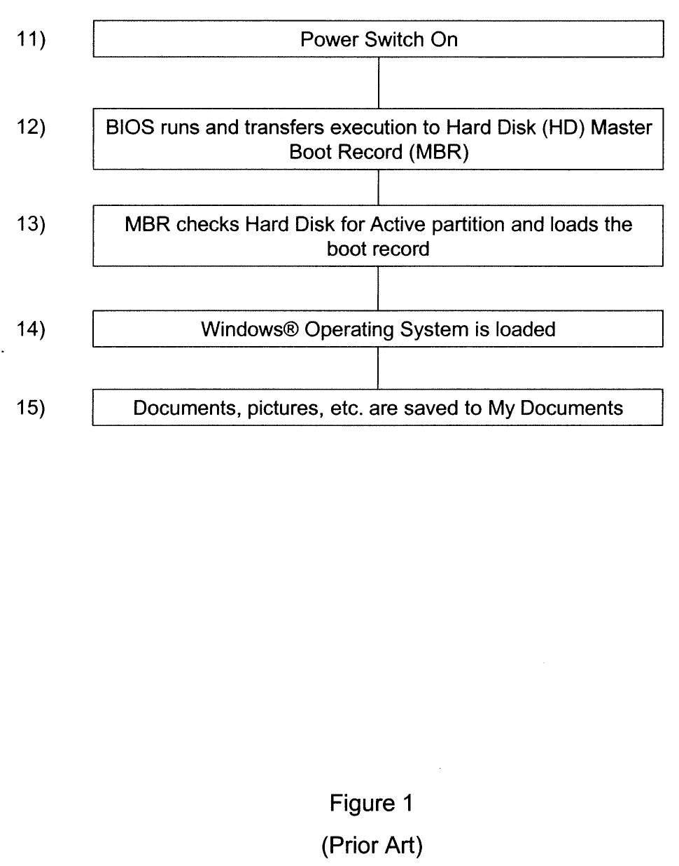

Turning now to FIG. 1, there is shown a prior art computer system boot process in which activation of a power switch provides power to the system in step 11. When power is provided, the basic input-output system (BIOS) runs and then transfers execution of the boot process to a hard disk (HD) master boot record (MBR) in step 12. The MBR checks the hard disk for an active partition and loads the boot record onto the active partition in step 13. The operating system (here, a Windows® operating system) is loaded in step 14. The operating system then saves files, including, but not limited to, document and picture files, according to a file structure recognized by the operating system, such as into a “My Documents” folder in step 15.

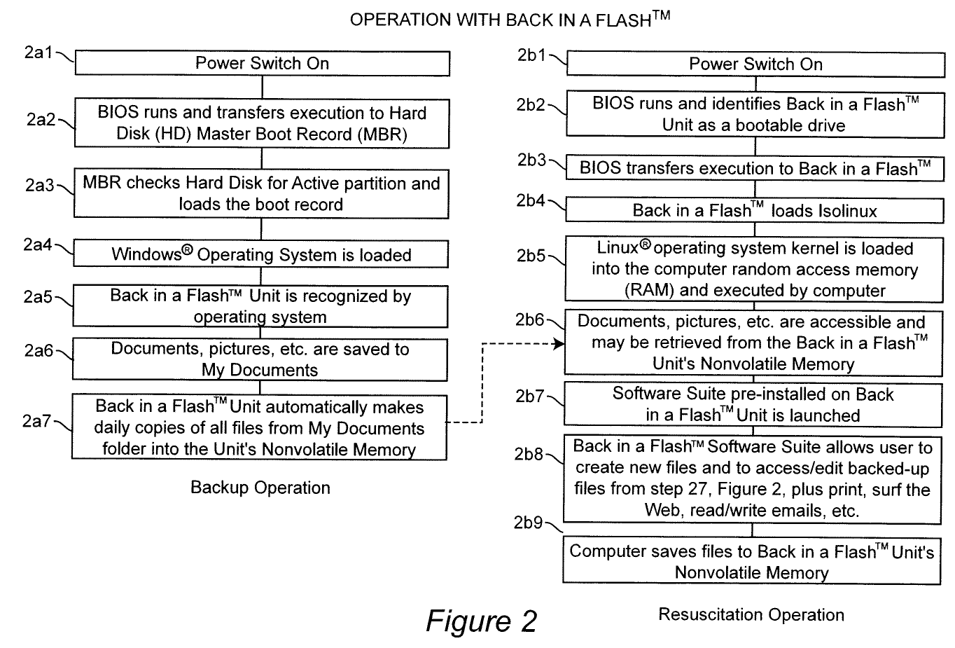

FIG. 2 shows, on the left side, the computer system boot process of the present invention in its initial role of making back-ups. The term Back in a Flash™, which is used herein, is a trade name for a product embodying the present invention. Activation of a power switch provides power to the system in step 2a1. When power is provided, the basic input-output system (BIOS) transfers execution of the boot process to a hard disk (HD) master boot record (MBR) in step 2a2. The MBR checks the hard disk for an active partition and loads the boot record onto the active partition in step 2a3, and the operating system (here, a Windows® operating system) is loaded in step 2a4. The Back in a Flash™ unit is recognized by the Windows® operating system in step 2a5. The operating system saves files, including, but not limited to, document and picture files, according to a file structure, such as into a “My Documents” folder in step 2a6. At a time set by the user, the Back in a Flash™ unit starts and copies all files from the My Documents folder into the Back in a Flash™ unit's nonvolatile memory in step 2a7; after the first back-up, only new or modified files are copied.

FIG. 2 shows, on the right side, the use of the present invention in its role of re-starting and providing effective operation of a computer after the computer suffers a crash of its hard disk or of its operating system. Activation of a power switch provides power to the system in step 2b1. When power is provided, the basic input-output system (BIOS) recognizes the Back in a Flash™ unit as a bootable drive in step 2b2 and, when the user elects to boot from the USB unit, transfers execution of the boot process to the Back in a Flash™ unit in step 2b3. Back in a Flash™ loads its emergency operating system (e.g., Isolinux) in step 2b4, and the Linux® operating system kernel is loaded into the volatile, random access memory (RAM) of the computer and run by the computer in step 2b5. Documents, pictures, etc. stored in the Back in a Flash™ unit are then accessible by the computer and may be retrieved in step 2b6. As shown in FIG. 2, the documents, pictures or other files that are backed up in step 2a7 are accessible from the nonvolatile memory of the Back in a Flash™ unit when the unit is operating in a resuscitation mode. The software suite pre-installed on the Back in a Flash™ unit is preferably compatible with the Linux® operating system and may be launched in step 2b7. The Back in a Flash™ software suite allows a user to work with new files or with the backed-up files previously saved inside the Back in a Flash™ unit, including creating, editing, or printing files, surf the web, read or write emails, and so forth, in step 2b8. Finally, the computer saves files to the Back in a Flash™ unit's nonvolatile memory in step 2b9.

Depending on the version of operating system selected for use as the emergency operating system, it may also be possible to gain access to the computer's hard disk and/or repair the hard disk's file allocation tables. However, there may be advantages (including, but not limited to, advantages relating to file size and licensing costs) in selecting an emergency operating system that does not offer that capability.

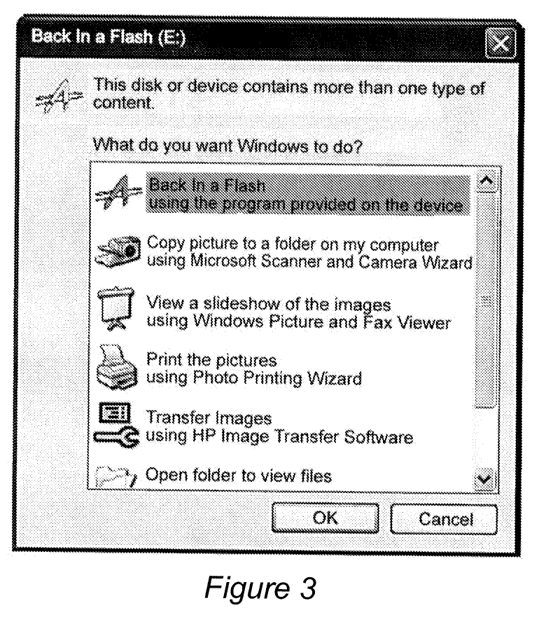

FIG. 3 is a screen shot of a hardware backup device according to the present invention being recognized by a computer in normal working mode after booting from its own internal operating system (here, a Windows® operating system).

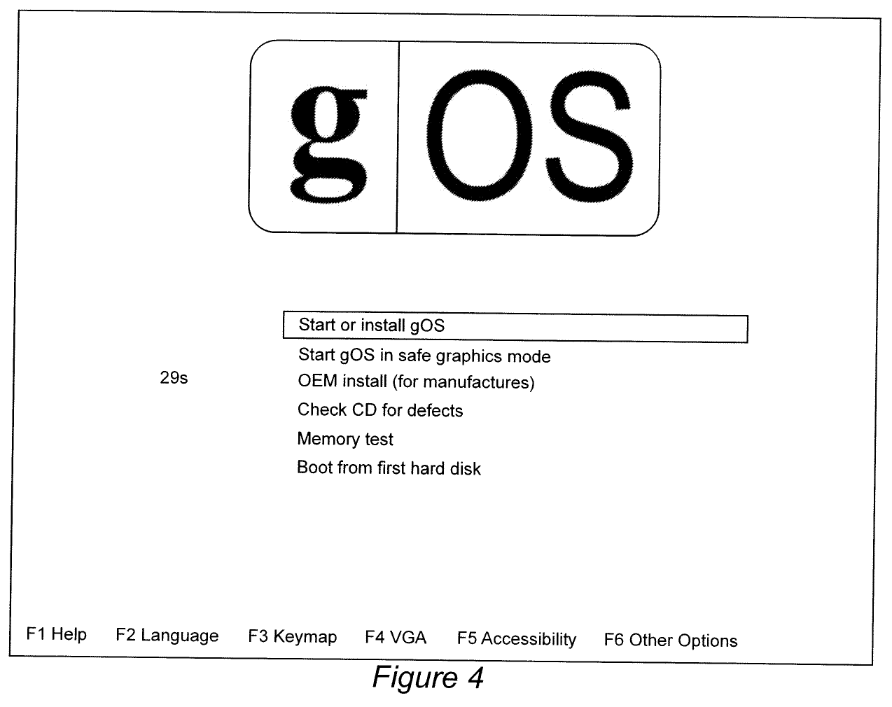

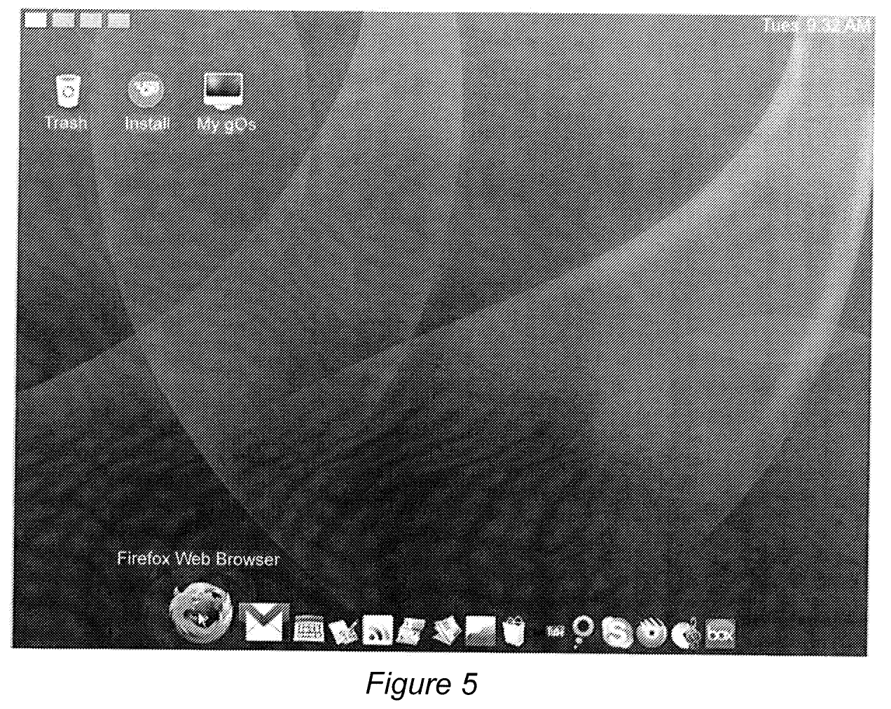

FIG. 4 is a screen shot showing the emergency operating system of the present invention being selected to boot a computer. As discussed above, the Back in a Flash™ unit will be recognized as a bootable drive (see FIG. 2b2) and the user can select from a variety of applications from a desktop as shown in FIG. 5.

FIG. 5 is a screen shot showing the desktop of a computer after booting from the emergency operating system as described above in connection with steps 2b5 and 2b6 of FIG. 2, and shows the icons for each of the productivity software programs along the bottom. The user is then free to operate the computer using the operating system of the Back in a Flash™ unit even when the operating system of the computer is not operable. Moreover, the computer's normal operating system and the operating system bootable from the Back in a Flash™ unit need not be the same operating system.

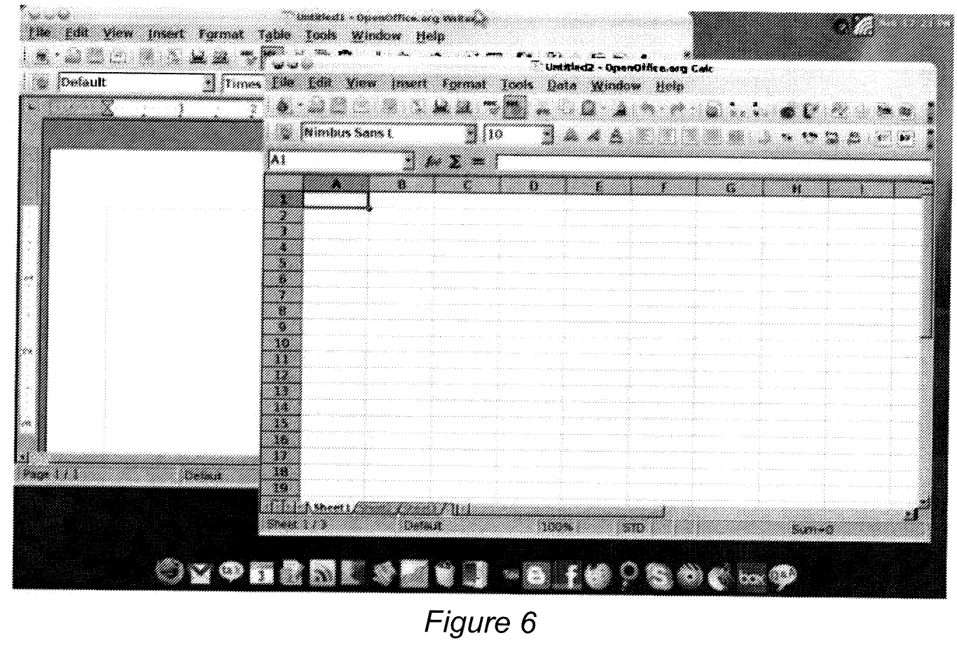

FIG. 6 is a screen shot of the product in use, launching an application from the productivity suite on the hardware device of the present invention. As discussed above in conjunction with steps 2b7 and 2b8, the user can use a variety of applications, including spreadsheets, word processors, browsers, email managers and so forth, which are stored on the Back in a Flash™ unit and run under the emergency operating system of the Back in a Flash™ unit.

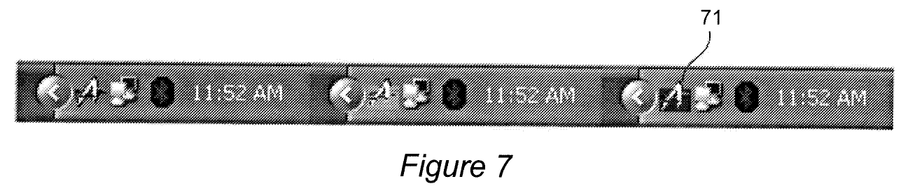

FIG. 7 is a screen shot of a computer with the hardware peripheral of the present invention, showing an icon for present invention in the system tray. The background of the icon fills up, for example, with the color green as the storage capacity of the present invention fills up with backed up files, and it changes from green to red when the back up storage capacity reaches a predetermined threshold of capacity utilization (e.g., 75% full or more). This provides the user with a warning to take appropriate action, such as, for example, transferring backup files to another storage device or acquiring a new Back in a Flash™ unit so that automatic daily backups are able to continue uninterrupted or to delete files from storage device of the present invention.

FIG. 8 shows a Back in a Flash™ hardware peripheral device 80 embodying the present invention, and configured with a USB connector 82, plugged into the USB port 84 of a computer 86.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A computer peripheral for backup, reboot, and recovery of a computer or data processing machine, comprising:
a data and software application storage medium; and
a computer connector associated with said data and software application storage medium for connecting said data and software application storage medium to a computer or data processing machine,
wherein said data and software application storage medium includes backup/recovery software which, upon activation and without installation of said backup/recovery software onto another storage medium of said computer or data processing machine, automatically backs up files prepared on said computer or data processing machine and stores said files on said data and software application storage medium in a non-volatile storage area, and
wherein said data and software application storage medium is recognizable by the computer or data processing machine as a boot drive and includes operating system software which, after attempts to boot said computer or data processing machine using software onboard said computer or data processing machine have failed, may be selected by the user to boot said computer or data processing machine.

2. The computer peripheral of claim 1 wherein said computer connector is connectable to a USB port.

3. The computer peripheral of claim 1 wherein said data and software application storage medium is provided on a PCMCIA card.

4. The computer peripheral of claim 1 wherein said data and software application storage medium is connected via an SATA port.

5. The computer peripheral of claim 1 wherein said operating system is a Linux operating system.

6. The computer peripheral of claim 1 wherein said data and software application storage medium includes a productivity suite of software programs including one or more of a word processing application, a spreadsheet application, a slide presentation application, an Internet browsing application, a voice over Internet application, and an email handling application, wherein each application of said productivity suite of software programs is operable without installation onto another storage medium of said computer or data processing machine.

7. The computer peripheral of claim 1 wherein said data and software application storage medium, with the productivity suite of software programs of claim 5, has access and may be used to open and edit the files backed-up in claim 1.

8. The computer peripheral of claim 1 wherein said backup/recovery software includes instructions to indicate in a system tray icon how full the storage capacity of the data and software application medium is and to cause said icon to change color when the ratio of used backup storage capacity to unused backup storage capacity reaches a threshold value.
